(19) United States
(12) Patent Application Publication
(10) Pub. No.: US 2016/0192412 A1
(43) Pub. Date: Jun. 30, 2016

(54) METHOD FOR CONTROLLING COMMUNICATION CHANNEL AND ELECTRONIC DEVICE SUPPORTING SAME

(71) Applicant: Samsung Electronics Co., Ltd., Gyeonggi-do (KR)

(72) Inventor: Kyusik CHO, Gyeonggi-do (KR)

(73) Assignee: Samsung Electronics Co., Ltd.

(21) Appl. No.: 14/979,872

(22) Filed: Dec. 28, 2015

(30) Foreign Application Priority Data
Dec. 24, 2014 (KR) 10-2014-0188588

(51) Int. Cl. H04W 76/02; H04W 72/08; H04W 4/00

(52) U.S. Cl. CPC H04W 76/02; H04W 4/008; H04W 72/085; H04W 88/06

(57) ABSTRACT

An electronic device and a communication channel control method are provided. The electronic device includes a communication unit that includes a first communication module and a second communication module having different types of communication schemes using frequency bands which overlap each other; and a processor that is connected to the first communication module and the second communication module, respectively, and determines a communication channel which can be used by the second communication module based on a connected communication channel and occupied communication channels which used by the first communication module.

### PRIORITY

This application claims priority under 35 U.S.C. §119(a) to Korean Patent Application Serial No. 10-2014-0188588, filed in the Korean Intellectual Property Office on Dec. 24, 2014, the contents of which are incorporated herein by reference.

### BACKGROUND

1. Field of the Disclosure

The present disclosure generally relates to a device and method for controlling a communication channel between communication modules having different types of communication schemes.

2. Description of the Related Art

With the remarkable development of information communication technology and semiconductor technology, the spread and use of electronic devices are rapidly increasing. Electronic devices initially provided a primary service such as voice calls, text message transmission, and the like. However, in recent years, the electronic device, such as a notebook computer, has provided a variety of services through the wireless Internet, for example, a mobile communication function, a short-range wireless communication function, a broadcast receiving function, an Internet connection function, etc.

However, when communication modules having different types of communication schemes using the same frequency band are provided in a single electronic device, performance degradation due to a frequency collision between the communication modules can occur. In order to avoid the frequency collision, the prior art has used methods for dividing a frequency band, dividing the usage time, periodically changing a frequency, retransmitting data, and the like.

A method for avoiding the frequency collision according to the prior art has the following problems. First, the method for dividing a frequency band has a problem in that the number of communication modules which can be connected is limited depending on a bandwidth of a communication scheme. In addition, the method for dividing a usage time may cause unintended time delay to a user and cause an inconvenience in use. The frequency change method may have an intermittent frequency overlap with another communication module during the frequency change. In the method for retransmitting data, when the performance degradation due to another communication module is severe, there may be a case in which the performance degradation cannot be overcome.

### SUMMARY

The present disclosure has been made to address at least the disadvantages described above and to provide at least the advantages described below. Accordingly, as aspect of the present disclosure provides a device and a method for preventing, even when different types of communication modules using the same frequency band are mounted on a single electronic device, the occurrence of frequency collision (or interference) between the communication modules.

According to an aspect of the present disclosure, an electronic device is provided. The electronic device includes a communication unit that includes a first communication module and a second communication module having different types of communication schemes using frequency bands which overlap each other; and a processor that is connected to the first communication module and the second communication module, respectively, and determines a communication channel which can be used by the second communication module based on a connected communication channel and occupied communication channels used by the first communication module.

According to an aspect of the present disclosure, a method for controlling a communication channel of an electronic device including a first communication module and a second communication module having different types of communication schemes using frequency bands which overlap each other is provided. The method includes acquiring occupied communication channels scanned by a first communication module in response to a connection request; identifying a connected communication channel used by the first communication module based on the occupied communication channels; and determining a communication channel which can be used by the second communication channel based on the connected communication channel and the occupied communication channels.

According to an aspect of the present disclosure, even when different types of communication modules using the same frequency band are mounted on a single electronic device, the occurrence of frequency collision (or interference) between the communication modules can be prevented.

According to an aspect of the present disclosure, even if a physical distance between different types of communication modules is not ensured to prevent the occurrence of the frequency collision, the frequency collision can be avoided and thus the electronic device can be miniaturized.

According to an aspect of the present disclosure, the frequencies can be periodically allocated (or changed) to a smooth communication providing channel and thus a good communication quality can be ensured.

### BRIEF DESCRIPTION OF THE DRAWINGS

The above and other aspects, features and advantages of the present disclosure will be more apparent from the following detailed description, taken in conjunction with the accompanying drawings, in which:

FIG. 1 is a diagram showing a result of sensitivity degradation depending on a spaced distance according to an embodiment of the present disclosure;

FIG. 2 is a diagram showing a result of a sensitivity measurement of a Zigbee® module according to an embodiment of the present disclosure;

FIG. 3 is a block diagram showing a configuration of an electronic device according to an embodiment of the present disclosure;

FIG. 4 is a flowchart showing a method for controlling a communication channel according to an embodiment of the present disclosure;

FIG. 5A is a diagram showing an example of determining a communication channel according to an embodiment of the present disclosure;

FIG. 5B is a diagram showing a result of a performance based on a communication channel according to an embodiment of the present disclosure; and

FIG. 6 is a diagram showing an operational relationship between different types of communication modules and a processor according to an embodiment of the present disclosure.

### DETAILED DESCRIPTION OF EMBODIMENTS OF THE PRESENT DISCLOSURE

Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation and it should be understood that the present disclosure includes all changes and/or equivalents and substitutes included in the spirit and scope of various embodiments of the present disclosure. In connection with descriptions of the drawings, similar components are designated by the same reference numeral.

In various embodiments of the present disclosure, the expressionS “or” or “at least one of A or/and B” include any or all of combinations of words listed together. For example, the expressionS “A or B” or “at least A or/and B” may include A, may include B, or may include both A and B.

The expressionS “1”, “2”, “first”, or “second” used in describing various embodiments of the present disclosure may modify various components of the various embodiments but do not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

The expression “configured to” used in the present disclosure may be replaced, according to certain situations, with “suitable for”. “having the capacity to”, “designed to”, “adapted to”, “made to”, or “capable of”. The term “configured to” may not always mean “specially designed to”. In some situations, “device configured to” may mean that the device can “do something” with other devices or components. For example, a context “processor configured to execute A, B, and C” may mean a dedicated processor (for example, embedded processor) for executing a corresponding operation, or a generic-purpose processor (for example, CPU or application processor) capable of executing corresponding operations by using at least one software program stored in a memory device.

The terms used in the present disclosure merely describe a specific embodiment, and are not intended to limit the scope of other embodiments. A singular form may include a plural form. All the terms including a technical or scientific term may have the same meaning as terms generally understood by those skilled in the prior art. The terms defined in a general dictionary may be interpreted as having the same or similar meaning in a context of related technology, and are not to be interpreted abnormally or excessively unless clearly defined in the present disclosure. According to certain situations, the terms defined in the present disclosure are not to be interpreted as excluding the embodiments of the present disclosure.

An electronic device according to various embodiments of the present disclosure may be a device including a projection function. For example, the electronic device may be one or a combination of a Home Gateway, a Home Automation, a Building Automation, a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and an electronic bracelet, an electronic necklace, an electronic appcessory, an electronic tattoo, and a smart watch.

According to some embodiments, the electronic device may be a smart home appliance having a projection function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM), and a Point Of Sale (POS) device of shops.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter, and the like) including a projection function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

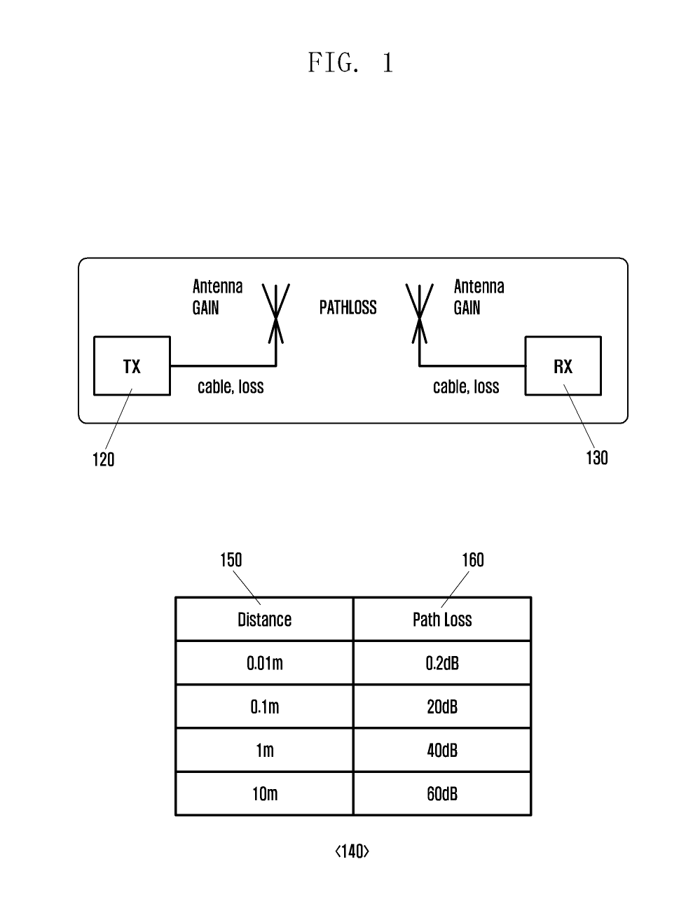

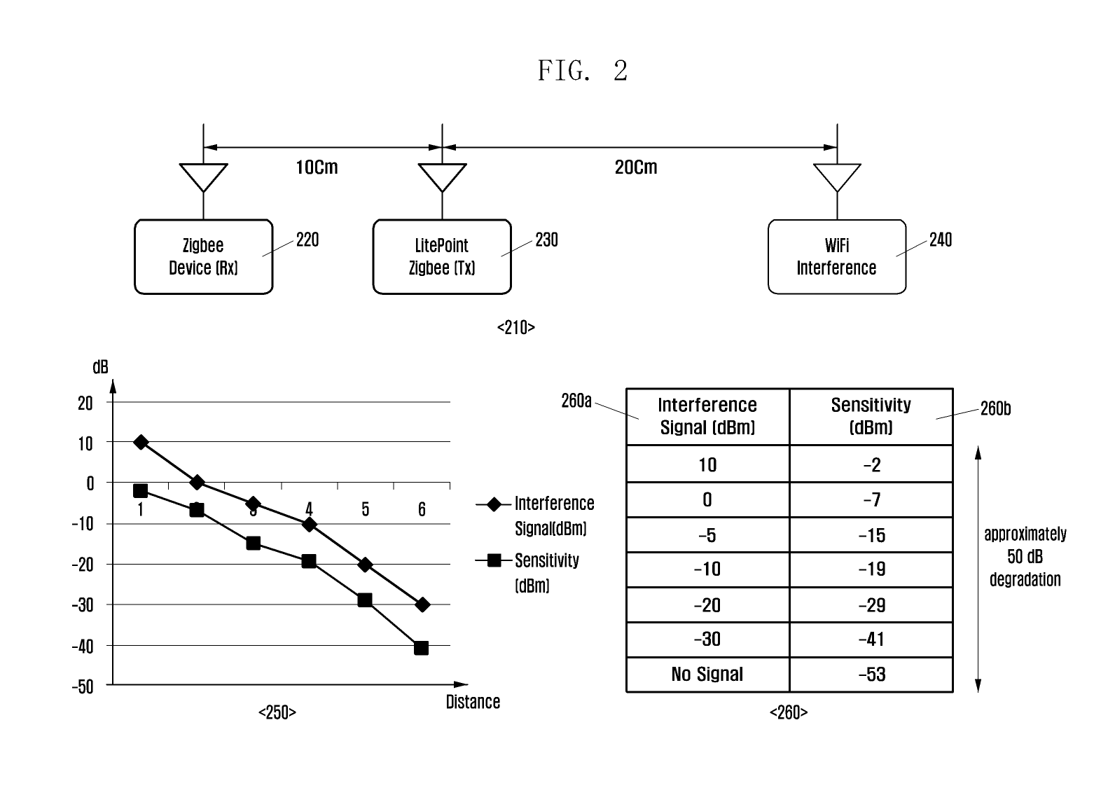

Since WiFi and Zigbee, which are representative communication schemes of a home gateway, use a same frequency band, when WiFi and Zigbee modules are mounted on a single device, an efficient frequency avoidance algorithm is required in order to ensure a performance of a communication module. In the following disclosure, as an example of communication modules having different types of communication schemes, a description will be given on WiFi and Zigbee schemes, but the different types of communication schemes are not limited to WiFi and Zigbee schemes. Hereinafter, FIGS. 1 and 2 illustrate, when the frequencies used for the WiFi and Zigbee schemes overlap, a sensitivity degradation is expected to occur.

FIG. 1 is a diagram showing a result of sensitivity degradation depending on a spaced distance according to an embodiment of the present disclosure.

Referring to in FIG. 1, reference numeral 120 indicates a transmitting side, for example, a WiFi antenna, and reference numeral 130 indicates a receiving side, for example, a Zigbee antenna. Since WiFi and Zigbee schemes use the same frequency band (for example, 2.4 GHz), the probability of the occurrence of the frequency interference is high. If the frequency interference occurs, the performance of the communication module is degraded and thus the communication quality is lowered. Therefore, a WiFi module and a Zigbee module have to ensure a minimum spaced distance in order to ensure good performance. A calculation of a Path Loss according to the spaced distance is defined by Equation (1) as follows.

$$F S P L ( dB ) = 10 {log ( \frac{4 π d f}{c} )}^{2} \qquad ( 1 )$$

FSPL means Free Space Path Loss, d is a distance, f is a frequency, and C is velocity of light. The Path Loss means that the signal intensity is weakened as a distance increases.

Table 140 indicates, if the frequency is 2.4 GHz, a path loss 160 corresponding to a spaced distance 150 between two communication modules calculated by Equation (1). When the spaced distance is 0.01 m, the path loss is 0.2 dB, when the spaced distance is 0.1 m, the path loss is 20 dB, when the spaced distance is 1 m, the path loss is 40 dB, and when the spaced distance is 10 m, the path loss is 60 dB.

For reference, referring to Institute of Electrical and Electronics Engineers (IEEE) 802.15.4, Signal-to-Noise Ratio (SNR) corresponding to −85 dB, which is Packet Error Rate (PER) <1%, is 5 dB to 6 dB. Therefore, an Interference Signal Level allowable for the SNR 5 dB may have a value of about −90 dB. Referring to Table 140 and Equation 1, when the spaced distance between the WiFi module and the Zigbee module is 10 m, it can be seen that the sensitivity degradation of about 60 dB is expected. The higher the sensitivity degradation, the lower the communication quality due to decrease in performance.

FIG. 2 is a diagram showing a result of sensitivity measurement of a Zigbee module according to an embodiment of the present disclosure.

Referring to FIG. 2, at reference numeral 210, an example of the occurrence of a signal interference when the spaced distance between a Zigbee device 220 which is a receiving side (Rx) of the IEEE802.11n and a LitePoint Zigbee device 230 which is a transmitting side (Tx) is 10 cm and the spaced distance between the LitePoint Zigbee device 230 and a WiFi module 240 is 20 cm is shown. For example, when a WiFi antenna 240 uses a frequency of 2442 MHz and the Zigbee antenna uses a frequency of 2440 MHz, the frequencies overlap and thus signal interference may occur.

Graph 250 represents the sensitivity measurement result depending on the spaced distance between the LitePoint Zigbee device which is the transmitting side (Tx) of the IEEE802.11n and the Zigbee device which is the receiving side (Rx). For reference, the sensitivity is measured in an environment of a bandwidth of 20 MHz, 1 Spatial stream, a Modulation and Coding Scheme (MCS) 2, BCC coding, and a sampling rate of 80 MHz in IEEE802.11n. Referring to graph 250, it can be seen that the sensitivity becomes worse as the spaced distance becomes greater.

Table 260 represents a table format of the graph 250. Referring to the Table 260, reference numeral 260a is dBm of an interference signal, and reference numeral 260b indicates dBm of the sensitivity. That is, when the signal interference between the Zigbee module and the WiFi module occurs, it can be seen that sensitivity degradation of approximately 50 dB may occur in the Zigbee module.

Therefore, WiFi and Zigbee need a spaced distance greater than a predetermined distance in order to reduce the sensitivity degradation. However, when mounting both the WiFi module and the Zigbee module on a single electronic device, in order to ensure the spaced distance, there is a disadvantage in that the size of the electronic device can be reduced only to a certain limit.

According to embodiments of the present disclosure, a method capable of avoiding the frequency collision even if the physical distance between different types of communication modules is not sufficient to prevent the occurrence of the frequency interference is provided.

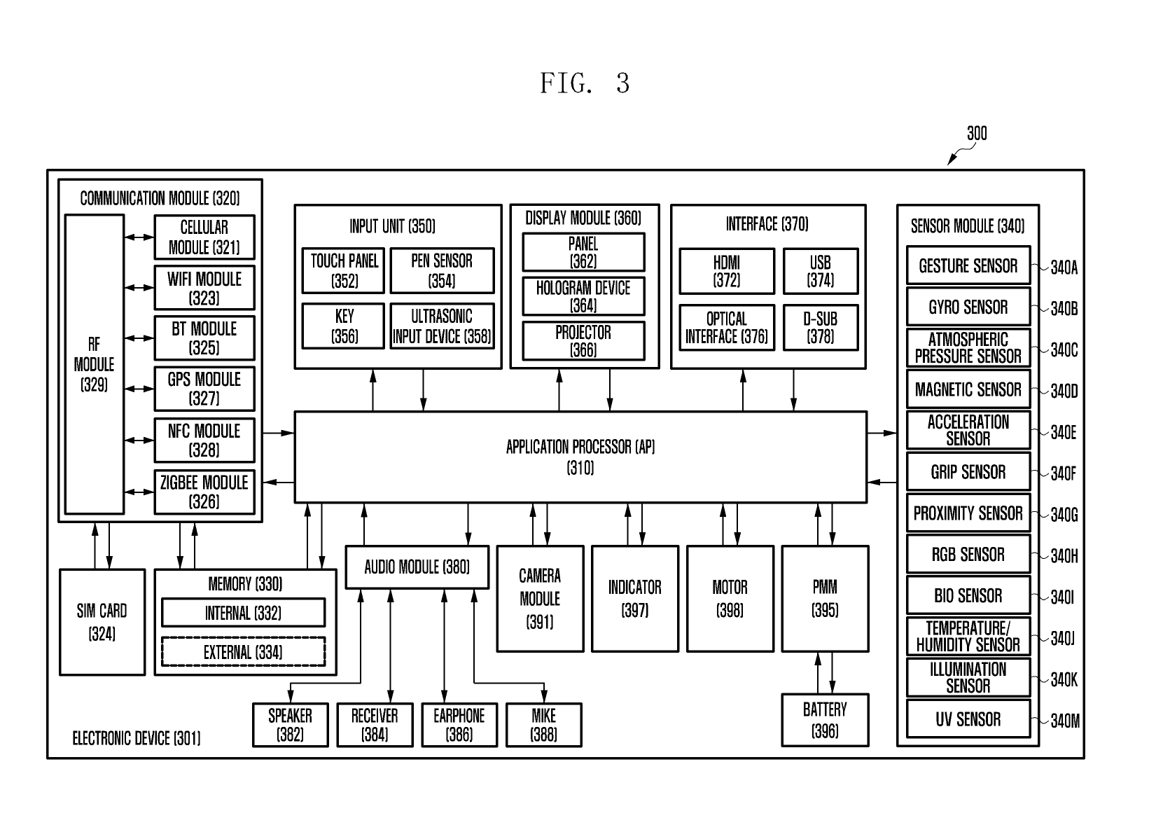

FIG. 3 is a block diagram 300 of an electronic device 301 according to an embodiment of the present disclosure.

Referring to FIG. 3, the electronic device 300 may include at least one Application Processor (AP) 310, a communication module 320, a Subscriber Identifier Module (SIM) card 324, a memory 330, a sensor module 340, an input device 350, a display module 360, an interface 370, an audio module 380, a camera module 391, a power management module (PMM) 395, a battery 396, an indicator 397, and a motor 398.

The processor 310 controls the overall operation of the electronic device 300 and a signal flow between the internal components of the electronic device 300, processes data, and controls power supplied from battery 396 to the other components. The processor 310 may include one or more of a Central Processing Unit (CPU), Graphic Processing Unit (GPU), an image signal processor, an Application Processor (AP), and a Communication Processor (CP). In the following, the processor 310 will be referred to as the processor 310 or AP 310.

The AP 310 may drive, for example, an operating system or an application program and control a plurality of hardware or software components connected to the AP 310. The AP 310 may be implemented by, for example, a System on Chip (SoC). The AP 310 may include at least a part of the components (for example, a cellular module 321) illustrated in FIG. 3. The AP 310 may load instructions or data, received from at least one other component (for example, a non-volatile memory), in a volatile memory to process the loaded instructions or data, and may store various types of data in a non-volatile memory.

The AP 310 may be connected to a first communication module (e.g., a WiFi module 323) and a second communication module (e.g., a ZIGBEE module 326) included in the communication module or unit 320, respectively. The AP 310 may identify a connected communication channel used by the first communication module 320 and an occupied communication channel scanned by the first communication module 320. The AP 310 may determine the communication channel of a second communication module based on the connected communication channel and the occupied communication channel. The AP 310 may control the second communication module to operate in the determined communication channel. On the other hand, when the second communication module is connected to a communication channel before the first communication module 320 is connected thereto, the AP 310 may connect the first communication module 320 to a pre-configured connected communication channel, and may re-configure the communication channel of the second communication module based on the pre-configured connected communication channel and the occupied communication channel.

The communication module 320 performs, under the control of the AP 310, a voice call, a video call, and data communication with an external device (for example, other electronic devices, a server, etc.) through a network (for example, a mobile communication network such as LTE, a wireless or wired LAN, etc.). The communication module 320 may include a radio frequency transmission unit for up-converting and amplifying the frequency of the signal to be transmitted, and a radio frequency receiving unit for low noise amplifying and down-converting the frequency of the received signal. The communication module 320 may include a plurality of modules that communicate with different types of communication schemes using frequency bands which overlap each other, which implies the same or a similar frequency band. For example, the first communication module 320 may be a WiFi module 323, and a second communication module may be a Zigbee module 326. The communication module 320 may include a cellular module 321, the WiFi module 323, a Bluetooth (BT) module 325, the Zigbee module 326, a Global Positioning System (GPS) module 327, a Near Field Communication (NFC) module 328, and a Radio Frequency (RF) module 329.

The cellular module 321 may provide a voice call, a video call, text message services, or Internet services through, for example, a communication network. The cellular module 321 may distinguish and authenticate electronic devices 300 within a communication network using the SIM card 324. The cellular module 321 may perform at least some functions which the AP 310 may provide. The cellular module 321 may include a Communication Processor (CP).

The WiFi module 323, the BT module 325, the GPS module 327, and the NFC module 328 may include, for example, a processor for processing data transmitted/received through a corresponding module. At least some (e.g., two or more) of the cellular module 321, the WiFi module 323, the BT module 325, the GPS module 327, and the NFC module 328 may be included in one Integrated Chip (IC) or in an IC package.

The RF module 329 may transmit/receive, for example, a communication signal (for example, an RF signal). The RF module 329 may include, for example, a transceiver, a Power Amp Module (PAM), a frequency filter, a Low Noise Amplifier (LNA) or an antenna. At least one of the cellular module 321, the WiFi module 323, the BT module 325, the GPS module 327, and the NFC module 328 may transmit/receive the RF signal through a separate RF module.

The SIM card 324 may include subscriber identification module and/or an embedded SIM, and contain unique identification information (for example, an Integrated Circuit Card Identifier (ICCID)) or subscriber information (for example, an International Mobile Subscriber Identity (IMSI)).

The memory 330 may include, for example, an internal memory 332 or an external memory 334. The internal memory 332 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a flash memory (for example, a NAND flash memory or a NOR flash memory), a hard disk driver, or a Solid State Drive (SSD).

The external memory 334 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 334 may be functionally and/or physically connected to the electronic device 300 through various interfaces.

The sensor module 340 may measure a physical quantity or detect an operation state of the electronic device 300, and may convert the measured or detected information into an electrical signal. The sensor module 340 may include at least one of a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (for example, red, green, and blue (RGB) sensor), a bio-sensor 340I, a temperature/humidity sensor 340J, an illumination sensor 340K, and a Ultra Violet (UV) sensor 340M. Additionally or alternatively, the sensor module 340 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 340 may further include a control circuit for controlling one or more sensors included in the sensor module 340. The electronic device 300 may further include a processor configured to control the sensor module 340 as a part of or separately from the AP 310, and may control the sensor module 340 while the AP 310 is in a sleep state.

The input device 350 may include, for example, a touch panel 352, a (digital) pen sensor 354, a key 356, and an ultrasonic input device 358. The touch panel 352 may be at least one of, for example, a capacitive type, a resistive type, an infrared type, and an ultrasonic type. The touch panel 352 may further include a control circuit. The touch panel 352 may further include a tactile layer, and provide a tactile reaction to a user.

The (digital) pen sensor 354 may include, for example, a recognition sheet which is a part of the touch panel or a separate recognition sheet. The key 356 may include, for example, a physical button, an optical key, and a keypad. The ultrasonic input device 358 may detect an acoustic wave using a microphone 388 of the electronic device 300 through an input tool generating an ultrasonic signal to identify data.

The display module 360 may include a panel 362, a hologram device 364, and a projector 366. The panel 362 may be implemented to be, for example, flexible, transparent, or wearable. The panel 362 may be configured as a single module integrated with the touch panel 352. The hologram device 364 may show a stereoscopic image in the air using interference of light. The projector 366 may project light onto a screen to display an image. The screen may be located, for example, inside or outside the electronic device 300. The display module 360 may further include a control circuit for controlling the panel 362, the hologram device 364, or the projector 366.

The interface 370 may include, for example, a High-Definition Multimedia Interface (HDMI) 372, a Universal Serial Bus (USB) 374, an optical interface 376, or a D-subminiature (D-sub) 378. Additionally or alternatively, the interface 370 may include, for example, a Mobile High-definition Link (MHL) interface, a Secure Digital (SD) card/Multi-Media Card (MMC) interface, or an Infrared Data Association (IrDA) standard interface.

The audio module 380 may bilaterally convert, for example, a sound and an electrical signal. The audio module 380 may process sound information input or output through, for example, a speaker 382, a receiver 384, earphones 386, the microphone 388, and the like.

The camera module 391 is a device which may photograph a still image and a dynamic image. The camera module 391 may include one or more image sensors (for example, a front sensor or a back sensor), a lens, an Image Signal Processor (ISP) or a flash (for example, LED or xenon lamp).

The power management module (PMM) 395 may manage, for example, power of the electronic device 300. The PMM 395 may include a Power Management Integrated Circuit (PMIC), a charger Integrated Circuit (IC), and a battery gauge. The PMIC may have a wired and/or wireless charging scheme. A magnetic resonance scheme, a magnetic induction scheme, or an electromagnetic scheme may be utilized as the wireless charging method, and an additional circuit for wireless charging, such as a coil loop, a resonance circuit, a rectifier, and the like may be added. The battery gauge may measure, for example, a remaining quantity of the battery 396, or a voltage, a current, or a temperature during charging. The battery 396 may include, for example, a rechargeable battery and/or a solar battery.

The indicator 397 may display a specific state of the electronic device 300 or the part (for example, the AP 310) of electronic device 300, for example, a boot up state, a message state, a charging state, and the like. The motor 398 may convert an electrical signal into mechanical vibration, and may generate vibration, a haptic effect, and the like. Although not illustrated, the electronic device 300 may include a processing unit (e.g., GPU) for supporting mobile TV. The processing device for supporting mobile TV may process media data according to a standard of Digital Multimedia Broadcasting (DMB), Digital Video Broadcasting (DVB), mediaflo and the like.

Each of the components of the electronic device according to the present disclosure may be implemented by one or more components and the name of the corresponding component may vary depending on a type of the electronic device. The electronic device may include at least one of the above-described elements. Some of the above-described elements may be omitted from the electronic device, or the electronic device may include additional elements. Further, some of the components of the electronic device according to the present disclosure may be combined to form a single entity, and thus, may equivalently execute functions of the corresponding elements prior to the combination.

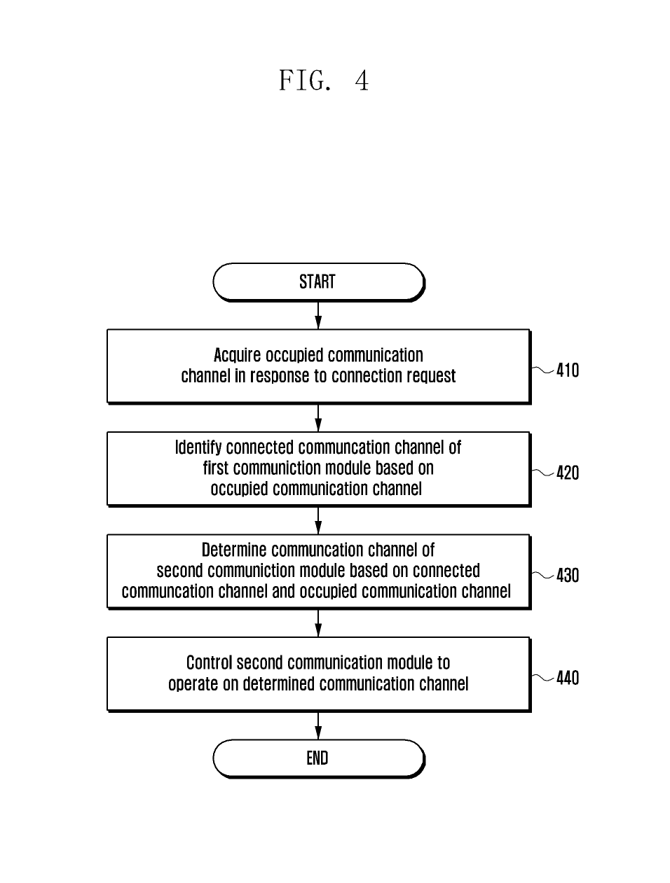

FIG. 4 is a flowchart showing a method for controlling a communication channel according to an embodiment of the present disclosure. The method for controlling the communication channel may be performed by the electronic device 300 of FIG. 3.

Referring to FIG. 3 and FIG. 4, in step 410, the processor 310 acquires an occupied communication channel in response to a connection request. The processor 310 may be connected to the first communication module (WiFi module 323) and a second communication module (Zigbee module 326), respectively. Here, the first communication module (WiFi module 323) may be wirelessly connected to neighboring WiFi devices. The first communication module 323 may scan for neighboring WiFi devices when the WiFi connection is requested. The first communication module 323 may scan for at least one neighboring WiFi device and periodically collect device information, such as device identifier (for example, name, ID) related to the scanned WiFi device, a frequency band which can be used to connected thereto, a signal strength, etc. The device information may include the occupied communication channel.

For reference, according to IEEE 802.11, the WiFi scheme uses a 2.4 GHz band, has a total of 14 channels (or communication channels), and the interval between channels is 5 MHz. Individual channels have a band of 22 MHz. The channels are not independent and overlap each other. Therefore, when four or more access points have been installed at the same hot spot zone, channel interference may occur.

The first communication module 323 transmits the collected information to the processor 310, and the processor 310 displays the collected device information through the display module 360. At this time, the processor 310 may sort the device information that is collected in the order of higher signal strength or in a sequence corresponding to a preferred access condition (e.g., if connected at least once before) and display the sorted device information on the display module 360.

In step 420, the processor 310 identifies a connected communication channel used by the first communication module 323 based on the occupied communication channel. The processor 310 may receive a selection, by a user, of at least one WiFi device among the device information displayed on the display module 360. On the other hand, the processor 310 may select at least one WiFi device based on the use history recorded in the electronic device 300. That is, the processor 310 may automatically select, without the user's selection, a WiFi device that previously has been connected to at least once. That is, the processor 310 may automatically select, when the WiFi connection is requested, any one WiFi device based on the device information scanned by the first communication module 323 and the usage information. The processor 310 transmits the selected device information to the first communication module 323, and the first communication module 323 connects with a WiFi device corresponding to the selected device information. That is, the first communication module 323 includes the selected WiFi device and the communication channel. As used herein, “connected communication channel” means a channel which is used by the first communication module 323, and “occupied communication channel” means a communication channel that is occupied by the WiFi device included in the device information. That is, the occupied communication channel means a communication channel occupied by neighboring WiFi devices which is not connected to the first communication module 323. The occupied communication channel may include a frequency to be used by the neighboring WiFi device and a signal strength of the neighboring WiFi device.

Therefore, the processor 310 may identify what kind of connected communication channel is used by the first communication module 323. In addition, although the processor 310 is not connected to the first communication module 323, the processor 310 may identify the device information collected by the first communication module 323.

The processor 310 may determine a communication channel of the second communication module 326 based on the connected communication channel and the occupied communication channel, in step 430. Here, the second communication module 326 is a Zigbee module and may be wirelessly connected to other neighboring Zigbee devices.

Based on WiFi characteristics, an access frequency (connected communication channel) cannot be changed. In addition, WiFi may extend the bandwidth to, depending on the situation, for example, 20 MHz, 40 MHz, and the like. In addition, WiFi may collect the occupied communication channels using Received Signal Strength Indicator (RSSI) information. On the other hand, Zigbee, based on characteristics thereof, may change an access frequency (or channel). In addition, for Zigbee, a plurality of end devices may be connected to a host controller. Further, for Zigbee, the bandwidth is typically fixed at 2 MHz. Therefore, the processor 310 may determine, based on the connected communication channel and the occupied communication channel, a communication channel to use for the second communication module 326 with a frequency less affected by the interference between the first communication module 323 and the second communication module 326.

In step 440, the processor 310 may control the second communication module 326 to operate on the determined communication channel. That is, the processor 310 may configure the second communication module 326 as the determined communication channel and thus may control a frequency accessible by the second communication module 326. At this time, based on characteristics thereof, since the bandwidth of WiFi can be extended, the processor 310 may periodically identify the communication channels occupied by neighboring WiFi devices and control the communication channel of the second communication module 326.

According to an embodiment of the present disclosure, the processor 310 may allocate the communication channel of the second communication module 326 by spacing the communication channel apart by more than a predetermined reference value from the connected communication channel used by the first communication module 323 or the occupied communication channel occupied by a WiFi device included in the device information. The reference value may be configured as a default by the user or by the electronic device 300. The reference value may be configured in consideration of the frequency spacing range for avoiding the frequency interference.

The processor 310 may determine a communication channel other than the connected communication channel and the occupied communication channel as the communication channel of the second communication module 326. On the other hand, the processor 310 may determine a communication channel among the occupied communication channels as a communication channel which can be used by the second communication module 326. The processor 310 may determine that a communication channel of the second communication module 326 overlaps a communication channel which has a signal strength lower than other communication channels from among the occupied connected communication channels. The processor 310 may determine a communication channel, which has a higher priority than other communication channels, as the communication channel of the second communication module 326, by applying a priority based on the connected communication channel and the occupied communication channel.

According to an embodiment of the present disclosure, the processor 310 may control the second communication module 326 to be connected to a communication channel other than the communication channel the first communication module 323 is connected thereto. Thereafter, if the first communication module 323 is required to be connected to the communication channel, the first communication module 323 may be connected to a pre-configured connected communication channel (for example, 2.4 GHz). Since the first communication module 323 scans, when connected to the communication channel, the communication channels occupied by neighboring WiFi devices, the processor 310 may re-configure the communication channel of the second communication module 326 based on the pre-configured connected communication channel and the occupied communication channels. That is, when the second communication module 326 is initially connected to the communication channel, the second communication module 326 may use a communication channel which should be used by the first communication module 323. In this case, since the first communication module 323 may not change the communication channel, based on characteristics thereof, the processor 310 may connect the first communication module 323 to the pre-configured connected communication channel, and re-configure the communication channel of the second communication module 326 at the same time, sequentially, or beforehand.

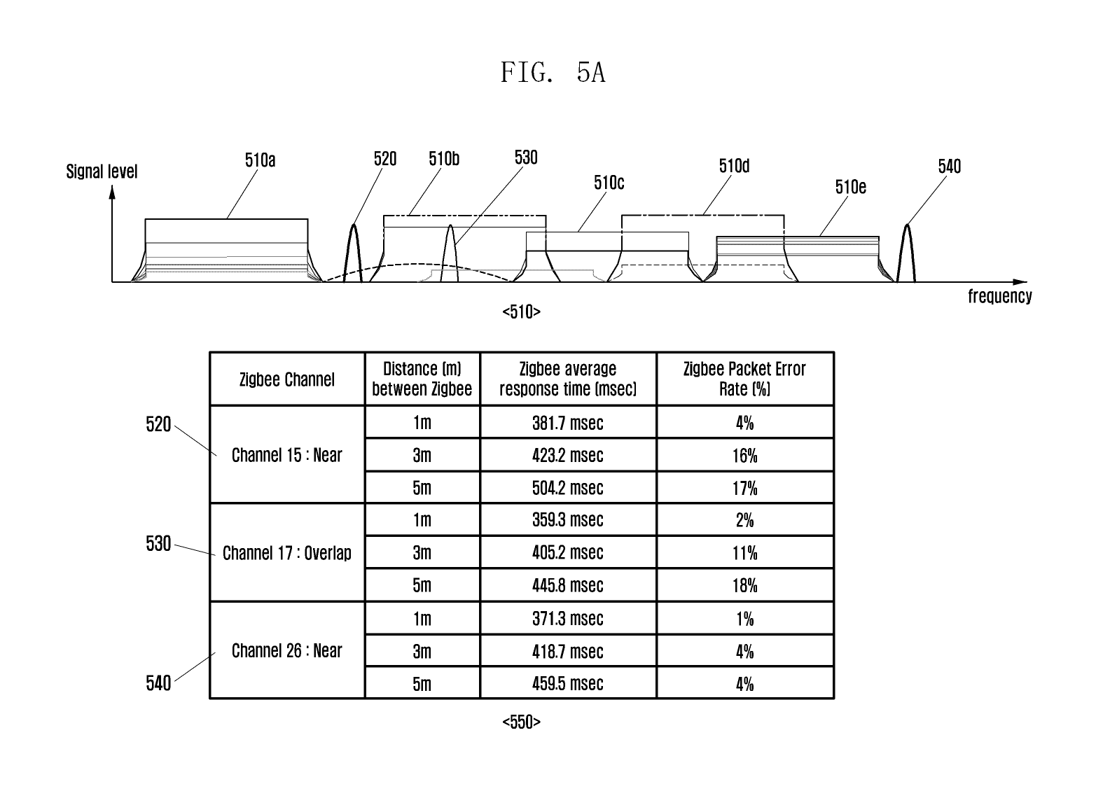

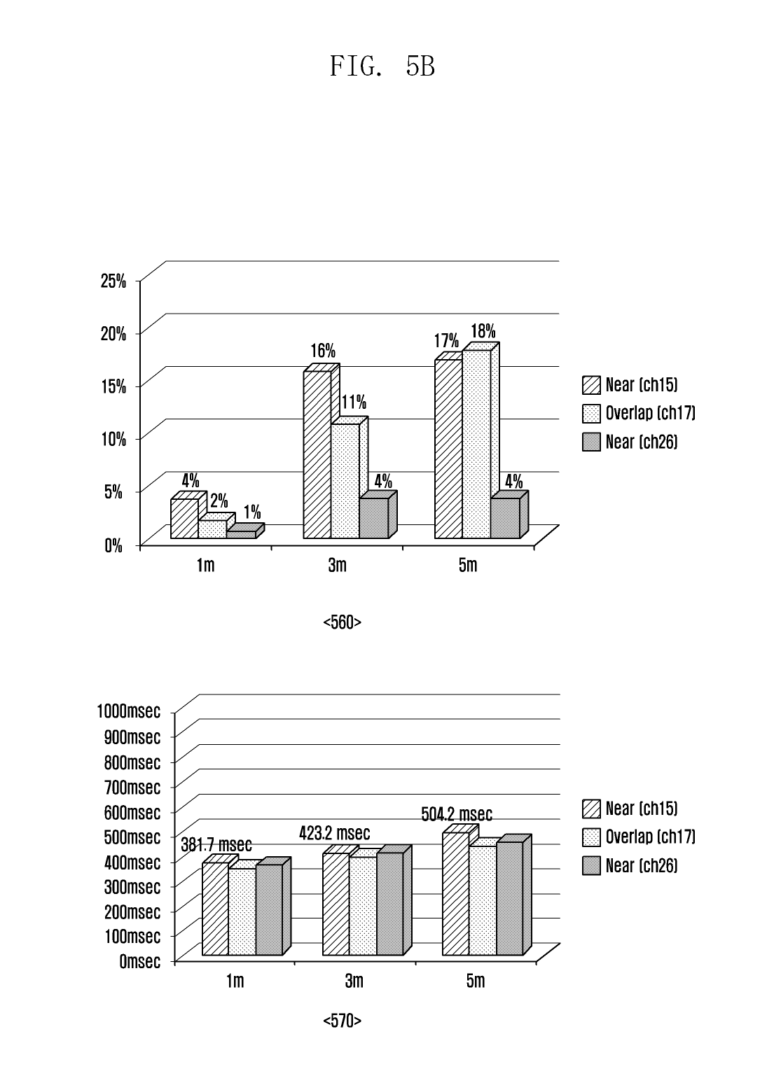

FIG. 5A is a diagram showing an example of determining a communication channel according to an embodiment of the present disclosure.

Referring to FIG. 3 and FIG. 5A, a graph 510 shows signal strengths for a connected communication channel 510a used by the first communication module 323 and communication channels 510b to 510e occupied by the WiFi device. The processor 310 may determine the communication channel of the second communication module 326 as at least one communication channel among the channels designated by reference numerals 520 to 540 based on the connected communication channel 510a and the occupied communication channels 510b to 510e.

Reference numeral 520 shows an example of allocating a communication channel, which does not overlap the connected communication channel 510a and the occupied connected communication channel 510b to 510e, to the communication channel of the second communication module 326. That is, the processor 310 may allocate a communication channel other than the connected communication channel 510a and the occupied communication channels 510b to 510e to the communication channel of the second communication module 326. On the other hand, reference numeral 520 may indicate a connected communication channel between the connected communication channel 510a and the occupied communication channel 510b.

Reference numeral 530 shows an example of allocating the communication channel of the second communication module 326 so as to overlap the communication channel 510b having the lowest signal strength among the occupied communication channels 510b to 510e. That is, the processor 310 may determine that the communication channel of the second communication module 326 overlaps the communication channel 510b which has a lower signal strength than other communication channels 510c to 510e among the occupied communication channels 510b to 510e.

Reference numeral 540 shows an example of allocating a communication channel spaced apart from the connected communication channel 510a and the occupied connected communication channels 510b to 510e to the communication channel of the second communication module 326. The processor 310 may allocate a communication channel farthest apart from the connected communication channel 510a and the occupied connected communication channels 510b to 510e to the communication channel of the second communication module 326. The processor 310 may determine a communication channel spaced apart more than a predetermined reference value to the communication channel of the second communication module 326. The reference value may be configured in consideration of the frequency spacing range to avoid the frequency interference.

In addition, the processor 310 may apply a priority based on an average response time and/or packet error rate of the connected communication channel 510a and the occupied communication channels 510b to 510e. The processor 310 may allocate a communication channel with the highest priority to the communication channel of the second communication module 326. That is, the processor 310 may variously apply the priorities based on the average response time and/or the packet error rate corresponding to the distance of the communication channels as shown with respect to reference numbers 520 to 540.

Table 550 that shows the average response time (msec) and the packet error rate based on the distance (m) between the communication modules for each of the communication channels shown by reference numerals 520 to 540. Referring to Table 550, it can be seen that the average response time and packet error rate differ depending on the distance between the communication modules. In order to ensure a good communication quality, a shorter average response time and a lower packet error rate are necessary. Therefore, the processor 310 may differently configure the priority for each communication channel by referring to the average response time and the packet error rate. For example, when figuring out the average response time and the packet error rate according to the distance for each of the communication channels 520 to 540, the processor 310 may set a higher priority in the order of the spaced communication channel 540, a non-overlapped communication channel 520, and an overlapped communication channel 530 having a lower signal strength.

FIG. 5B is a diagram showing a result of a performance based on a communication channel according to an embodiment of the present disclosure.

Referring to FIG. 3 and FIG. 5B, graph 560 simply compares packet error rates for each of communication channels by referring to Table 550. The non-overlapped communication channel 520 is referred to as Near Ch 15, the communication channel 530 having a lower signal strength is referred to as Overlap Ch 17, and the spaced communication channel 540 is referred to as Near Ch 26. Referring to graph 560, the processor 310 may set a higher priority in the order of the communication channel 540 spaced with respect to a lower packer error rate, the overlapped communication channel 530 having a lower signal strength, and the non-overlapped communication channel 520. On the other hand, the processor 310 may variously apply the priorities based on a shorter distance and a lower packet error rate.

Graph 570 compares the average response time for each communication channel with reference to Table 550. Referring to graph 570, the processor 310 may set a higher priority in the order of, with reference to a shorter response time, the overlapped communication channel 530 having a lower signal strength, the spaced communication channel 540, and the non-overlapped communication channel 520. On the other hand, the processor 310 may variously apply the priorities based on a shorter distance and a shorter response time.

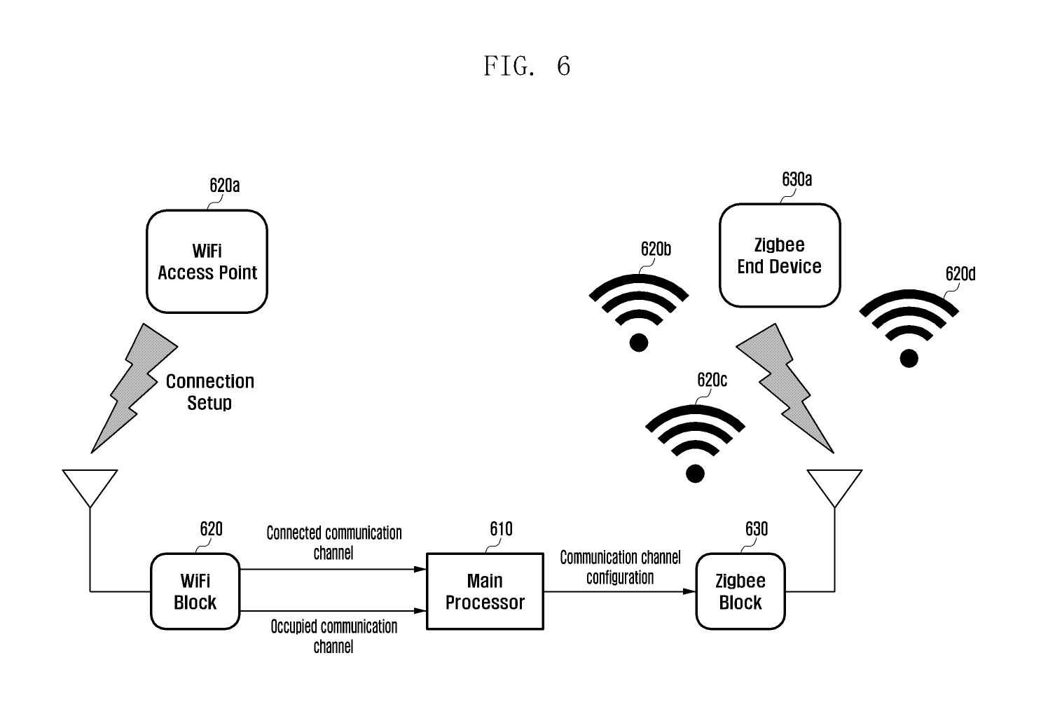

FIG. 6 is a diagram showing an operational relationship between different types of communication modules and a processor according to an embodiment of the present disclosure.

Referring to FIG. 6, a main processor 610 of the electronic device (e.g., the electronic device 300 in FIG. 3) may be connected to a WiFi block 620 and a Zigbee block 630, respectively. The WiFi block 620 may periodically transmit a connected communication channel in use and an occupied communication channel to the main processor 610.

The WiFi block 620 may scan for neighboring WiFi devices when a WiFi access is requested. That is, the WiFi block 620 may detect a signal transmitted from a WiFi Access Point 620a and neighboring WiFi devices 620b to 620d, and request the WiFi Access Point 620a and the neighboring WiFi devices 620b to 620d for device information. The WiFi Access Point 620a and the neighboring WiFi devices 620b to 620d may transmit, in response to the request, the device information, such as device identifiers thereof, connectable frequencies, and signal strengths to the WiFi block 620. The WiFi block 620 may receive the device information and transmit the device information to the main processor 610.

The main processor 610 may receive any information, selected by the user, among the device information, or automatically select information without the user's selection based on the use history recorded and stored in the electronic device. The main processor 610 transmits the selected device information to the WiFi block 620 and may connect the WiFi block 620 to the WiFi device (for example, WiFi Access Point 620a) corresponding to the selected device information. Through the above process, the main processor 610 may acquire the connected communication channel and the occupied communication channels. Here, the connected communication channel is a communication channel used by the WiFi block 620, and the occupied communication channels may include a frequency, signal strength, etc. occupied by WiFi neighboring devices 620b to 620d.

The main processor 610 may configure a communication channel of the Zigbee block 630 based on the connected communication channel and the occupied communication channels and transmit the configured communication channel to the Zigbee block 630. That is, the main processor 610 may configure a communication channel spaced farthest from the connected communication channel or the occupied communication channel as the communication channel of the Zigbee block 630. Also, the main processor 610 may configure a communication channel other than the connected communication channel and the occupied communication channel as the communication channel of the Zigbee block 630. On the other hand, the main processor 610 may configure a communication channel which does not overlap the occupied communication channels as the communication channel of the Zigbee block 630.

The main processor 610 may configure the communication channel of the Zigbee block 630 to overlap a communication channel having a lower signal strength compared to other communication channels among the occupied communication channels. According to an embodiment of the present disclosure, the main processor 610 may configure a communication channel having a higher priority than other communication channels as the communication channel of the of the Zigbee block 630, by applying a priority based on the connected communication channel and the occupied communication channel. The Zigbee block 630 may be connected to the Zigbee End Device 630 a using the configured communication channel.

While the present invention disclosure has been particularly shown and described with reference to certain embodiments thereof, it will be understood by those skilled in the art that various changes in form and details may be made therein without departing from the spirit and scope of the invention. Therefore, the scope of the present disclosure should not be defined as being limited to these embodiments, but should be defined by the appended claims and equivalents thereof.

What is claimed is:

1. An electronic device comprising:
a communication unit that includes a first communication module and a second communication module having different types of communication schemes using frequency bands which overlap each other; and
a processor that is connected to the first communication module and the second communication module, respectively, and determines a communication channel which can be used by the second communication module based on a connected communication channel and occupied communication channels used by the first communication module.

2. The electronic device of claim 1, wherein the first communication module corresponds to a WiFi module, and the second communication module corresponds to a Zigbee module.

3. The electronic device of claim 2, wherein the first communication module scans for neighboring WiFi devices according to a connection request, transmits device information on the scanned WiFi devices to the processor, and connects to a WiFi device according to an instruction of the processor.

4. The electronic device of claim 3, wherein the occupied communication channels are communication channels occupied by the WiFi devices included in the device information.

5. The electronic device of claim 1, wherein the processor determines a communication channel spaced at least a predetermined reference value from the connected communication channel and the occupied communication channels as the communication channel of the second communication module.

6. The electronic device of claim 1, wherein the processor determines a communication channel other than the connected communication channel and the occupied communication channels as the communication channel of the second communication module.

7. The electronic device of claim 1, wherein, when the second communication module is connected to a communication channel before the first communication module is connected thereto, the processor connects the first communication module to a pre-configured connected communication channel and re-configures the communication channel of the second communication module based on the pre-configured connected communication channel and the occupied communication channels.

8. The electronic device of claim 1, wherein the processor determines that the communication channel of the second communication module overlaps the communication channel having a signal strength lower than the other occupied communication channels from among the occupied communication channels.

9. The electronic device of claim 1, wherein the processor applies a priority based on one of an average response time and a packet error rate of the connected communication channel and the occupied communication channels, and determines a communication channel having a higher priority than other communication channels as the communication channel of the second communication module.

10. A method for controlling a communication channel of an electronic device including a first communication module and a second communication module having different types of communication schemes using frequency bands which overlap each other, comprising:
acquiring occupied communication channels scanned by the first communication module in response to a connection request;
identifying a connected communication channel used by the first communication module based on the occupied communication channels; and
determining a communication channel which can be used by the second communication channel based on the connected communication channel and the occupied communication channels.

11. The method of claim 10, wherein the first communication module corresponds to a WiFi module, and the second communication module corresponds to a Zigbee module.

12. The method of claim 11, wherein acquiring the occupied communication channels comprises:
scanning for neighboring WiFi devices by the first communication module; and
acquiring occupied communication channels using device information on the scanned WiFi devices.

13. The method of claim 12, wherein the occupied communication channels are communication channels occupied by the WiFi devices included in the device information.

14. The method of claim 10, wherein determining the communication channel comprises:
determining a communication channel spaced at least a predetermined reference value from the connected communication channel and the occupied communication channels as the communication channel of the second communication module.

15. The method of claim 10, wherein determining the communication channel comprises:
determining a communication channel other than the connected communication channel and the occupied communication channels as the communication channel of the second communication module.

16. The method of claim 10, further comprising:
connecting the first communication module to a pre-configured connected communication channel when the second communication module is connected to the communication channel before the first communication module is connected thereto; and
re-configuring the communication channel of the second communication module based on the pre-configured connected communication channel and the occupied communication channels.

17. The method of claim 13, wherein determining the communication channel comprises:
determining that the communication channel of the second communication module overlaps the communication channel having a signal strength lower than other communication channels from among the occupied communication channels.

18. The method of claim 13, wherein determining the communication channel comprises:
applying a priority based on an average response time and a packet error rate of the connected communication channel and the occupied communication channels; and
determining a communication channel having a higher priority than other communication channels as the communication channel of the second communication module.
